(19) United States
(12) Patent Application Publication
(10) Pub. No.: US 2025/0290012 A1
(43) Pub. Date: Sep. 18, 2025

(54) Garment Manufacturing System

(71) Applicants: Agustin Ramirez Aguilar, Los Angeles, CA (US); Jose Angel Carrillo Cordero, Puebla (MX); Pedro Javier Chavez Robles, Chihuahua (MX)

(72) Inventors: Agustin Ramirez Aguilar, Los Angeles, CA (US); Jose Angel Carrillo Cordero, Puebla (MX); Pedro Javier Chavez Robles, Chihuahua (MX)

(21) Appl. No.: 18/603,131

(22) Filed: Mar. 12, 2024

(51) Int. Cl. C11D 3/386; C11D 3/04; C11D 3/10; C11D 3/39; C11D 3/43; D06B 1/02; D06B 23/20; D06F 23/02; D06F 35/00; D06F 39/02; D06F 39/08; D06M 16/00; D06M 101/06

(52) U.S. Cl. CPC C11D 3/3869; C11D 3/044; C11D 3/10; C11D 3/3942; C11D 3/43; D06B 1/02; D06B 23/205; D06F 23/025; D06F 35/001; D06F 39/02; D06F 39/088; D06M 16/003; D06M 2101/06; D06M 2200/50

(57) ABSTRACT

A garment manufacturing system and methods, providing lower water consumption, energy consumption, and chemical consumption, that can include a washing machine, positioning a spray nozzle within the washing machine, and coupling a high pressure pump to the spray nozzle, the spray nozzle being configured to atomize within the washing machine which can include a catalyst, a humectant, and water.

### TECHNICAL FIELD

This disclosure relates to garment manufacturing, more particularly to garment finishing processes and machines.

### BACKGROUND

Garments are an integral facet of modern life. The global garment market is expansively large, any improvements in the manufacturing process can have a dramatic impact as each improvement may be reproduced in every garment produced.

One popular segment of the garment industry is denim, which includes the process of washing and processing denim. This creates the popular and comfortable appearance of denim materials such as denim jeans, denim shirts, and denim jackets.

Typically, producing denim garments includes a first step of “Ginning”. In the ginning step, cotton is gathered and put into machines where it is untangled and spun together into strong threads. A second step of “Dyeing” consists of dipping the threads several times into tubs of synthetic dye.

A third step is the “Woven Stage”, during which time the threads are woven together either through selvage or warp and weft. A fourth step consists of the “Finishing Stage”.

During the finishing stage the denim is sanforized, which means it is stretched, heated, and shrunk down. The finishing stage can also include a variety of washings like pre-washing, stone washing or acid washing.

Pre-washing can utilize industrial detergents to make the denim softer. The pre-washing is usually done prior to the stone washing or acid washing. The stone washing and the acid washing can provide a certain faded or worn look that is a popular denim appearance.

The finishing stage is notoriously wasteful in its extremely high water usage, its high energy usage, and its use of large quantities of chemicals. This finishing stage waste contributes to a large environmental cost as the water is diverted from other needs, the energy is diverted from other needs, and the chemical waste must be properly disposed of.

The finishing stage wastes increases financial costs from excessive use of water, power, and chemicals, which impacts and lowers profit margins. There remains a need for garment manufacturing systems and processes that can operate without losing the original quality of the garment and use less resources. Furthermore, a need remains for a garment manufacturing systems and processes that remove protectors, dyes, gums, and contaminants in the cotton using less water, less energy, and fewer chemicals. Even small improvements in the processing of fabrics can create huge benefits as the improvements can be multiplied by each of the millions of clothing articles produced every year.

Solutions have been long sought but prior developments have not taught or suggested any complete solutions, and solutions to these problems have long eluded those skilled in the art. Thus, there remains a considerable need for finishing stage manufacturing systems and methods that can lower water consumption, energy consumption, and chemical consumption.

### SUMMARY

A garment manufacturing system and methods, providing lower water consumption, energy consumption, and chemical consumption, are disclosed. The garment manufacturing system and methods can include: providing a washing machine; positioning a spray nozzle within the washing machine; and coupling a high pressure pump to the spray nozzle, the spray nozzle being configured to atomize within the washing machine: a catalyst, a humectant, and water.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The garment manufacturing system is illustrated in the figures of the accompanying drawings which are meant to be exemplary and not limiting, in which like reference numerals are intended to refer to like components, and in which:

FIG. 1 is a block diagram of the garment manufacturing system.

FIG. 2 is a flow chart for a method of operating the garment manufacturing system of FIG. 1.

FIG. 3 is a front isometric view of the washing machine system of FIG. 1 in a first embodiment.

FIG. 4 is a back isometric view of the washing machine system of FIG. 1.

FIG. 5 is a front isometric view of the Area A of FIG. 3.

FIG. 6 is an internal isometric view of the spray nozzle of FIG. 5.

FIG. 7 is a front isometric view of the hatch of FIG. 3.

FIG. 8 is a front isometric view of the washing machine system of FIG. 1 in a second embodiment.

FIG. 9 is a graphical depiction of an atomization tank interface panel for the washing machine system of FIG. 1.

FIG. 10 is an isometric view of the high pressure pump of FIG. 3.

FIG. 11 is a front isometric view of components used with the garment manufacturing system.

FIG. 12 is an isometric view of the ozone machine system of FIG. 1.

FIG. 13 is a top view of an electronic card for the concentrator tanks of FIG. 12.

FIG. 14 is a front isometric view of a load 1 step of the washing machine system for the garments.

FIG. 15 is a front isometric view of a first chemical load step of the washing machine system.

FIG. 16 is a front isometric view of an extract 1 step of the washing machine system for the garments.

FIG. 17 is a front isometric view of a load 3 step of the ozone machine system for the garments, the abrasives, and the towels.

FIG. 18 is a front isometric view of an extract 3 step of the ozone machine system for the garments, the abrasives, and the towels.

FIG. 19 is a front isometric view of a load 4 step for the garments.

FIG. 20 is a front isometric view of a chemical loading step.

FIG. 21 is a front isometric view of an atomization check step.

FIG. 22 is a front isometric view of a moisture monitoring step for the towels and abrasives during the preparation step of FIG. 2.

FIG. 23 is a front isometric view of a quality assurance step for the garments.

FIG. 24 is a block diagram of a method of assembling the garment manufacturing system.

### DETAILED DESCRIPTION

In the following description, reference is made to the accompanying drawings that form a part hereof, and in which are shown by way of illustration, embodiments in which the garment manufacturing system may be practiced. It is to be understood that other embodiments may be utilized and structural changes may be made without departing from the scope of the garment manufacturing system.

When features, aspects, or embodiments of the garment manufacturing system are described in terms of steps of a process, an operation, a control flow, or a flow chart, it is to be understood that the steps can be combined, performed in a different order, deleted, or include additional steps without departing from the garment manufacturing system as described herein.

The garment manufacturing system is described in sufficient detail to enable those skilled in the art to make and use the garment manufacturing system and provide numerous specific details to give a thorough understanding of the garment manufacturing system; however, it will be apparent that the garment manufacturing system may be practiced without these specific details.

In order to avoid obscuring the garment manufacturing system, some well-known system configurations and descriptions are not disclosed in detail. Likewise, the drawings showing embodiments of the system are semi-diagrammatic and not to scale and, particularly, some of the dimensions are for the clarity of presentation and are shown greatly exaggerated in the drawing FIGs.

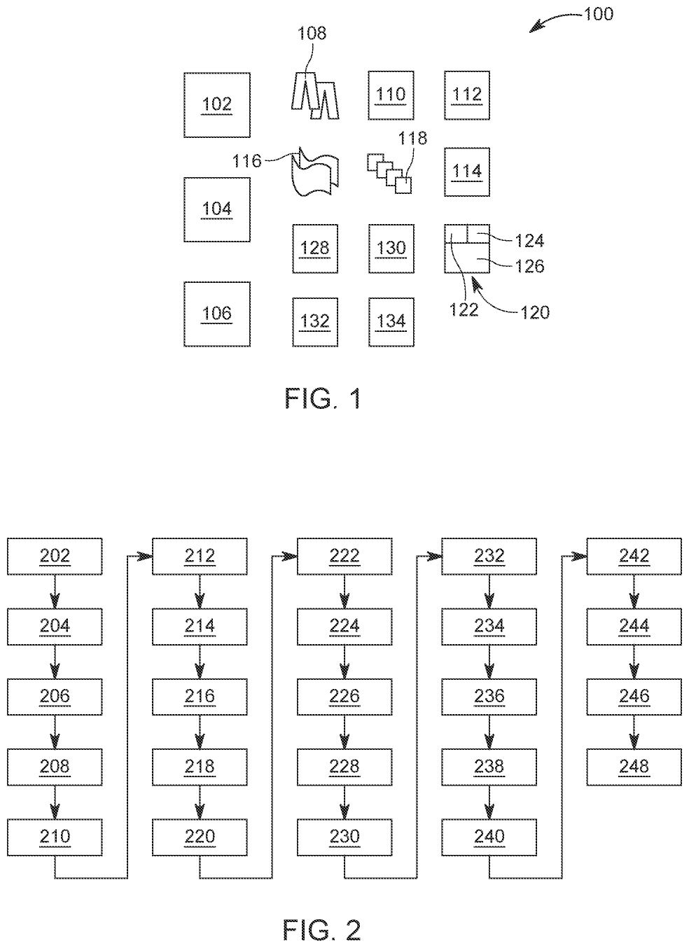

Referring now to FIG. 1, therein is shown a block diagram of the garment manufacturing system. The garment manufacturing system 100 can be comprised of a washing machine system 102, a drying machine system 104, and an ozone machine system 106.

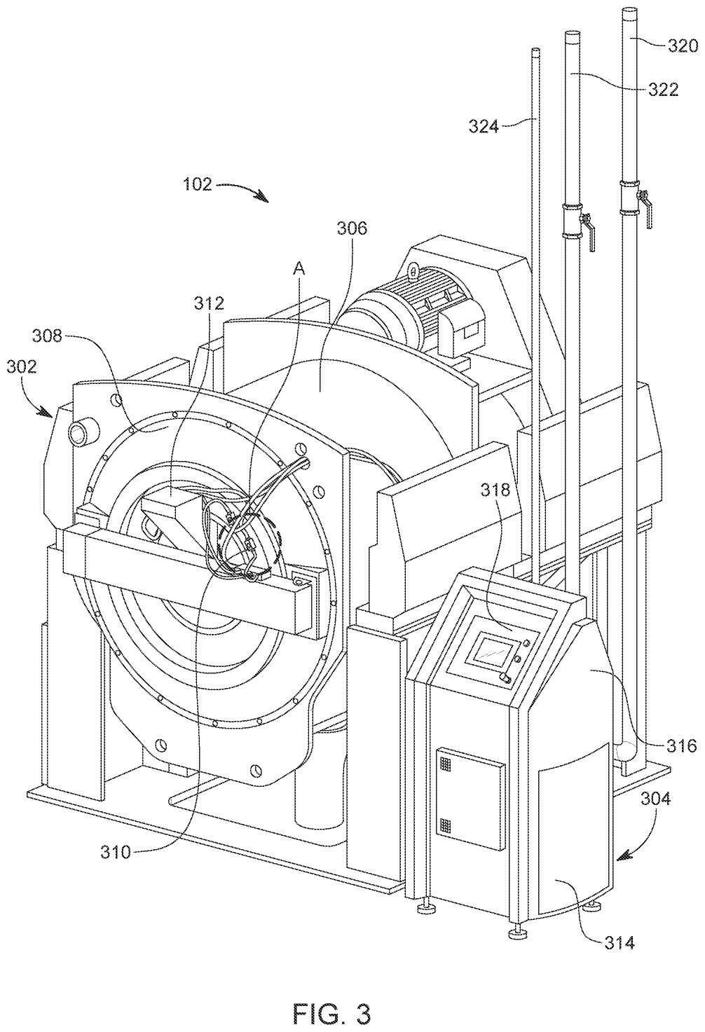

The washing machine system 102 can itself be comprised of many subsystems, components, and machines, which are depicted in and described with regard to FIGS. 3-10. Furthermore, the operation of the washing machine system 102 is depicted in and described with regard to FIGS. 14-16, and 19-23.

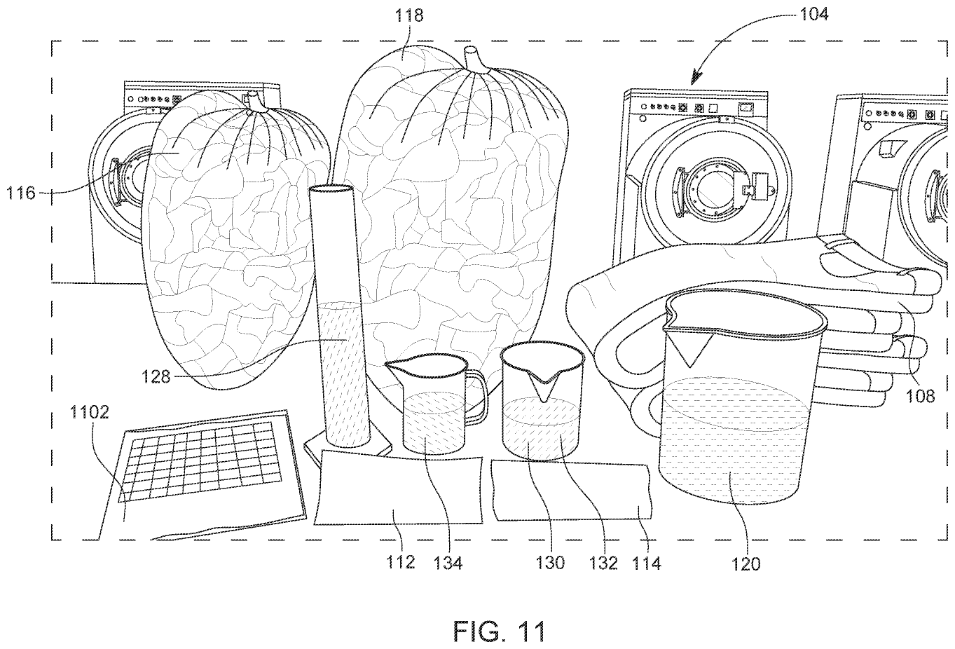

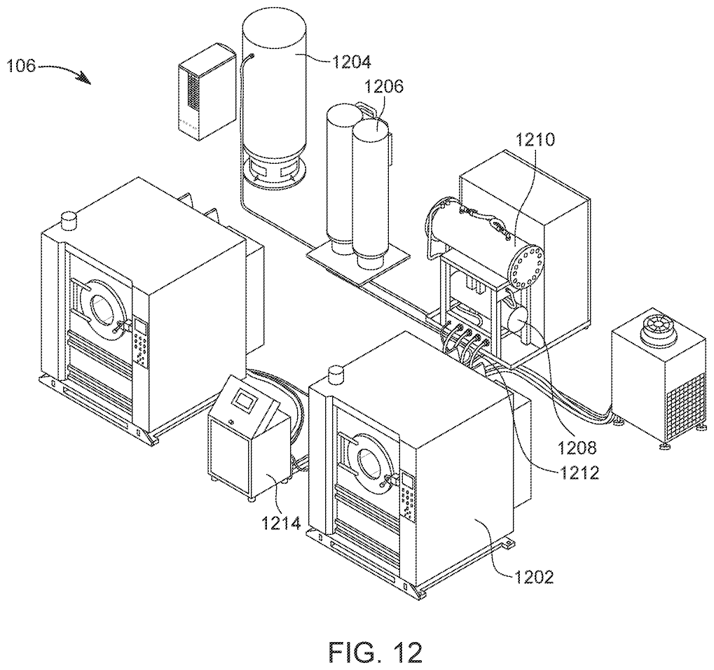

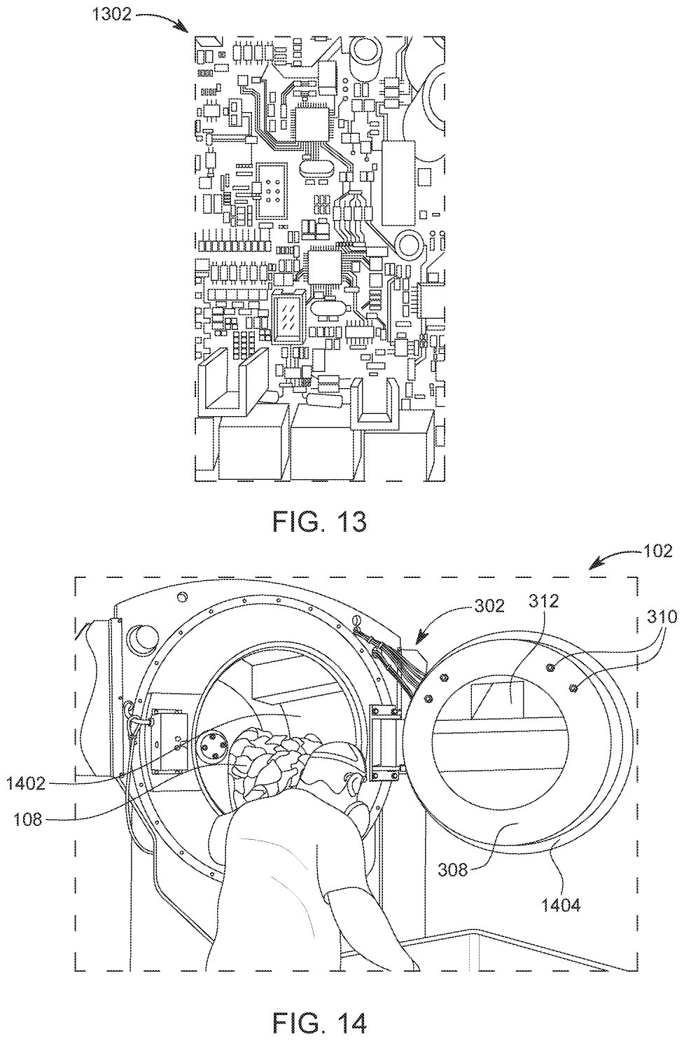

The drying machine system 104 can also be comprised of many subsystems, components, and machines, which are depicted in and described with regard to FIG. 11. The ozone machine system 106 can also be comprised of many subsystems, components, and machines, which are depicted in and described with regard to FIGS. 12 and 13.

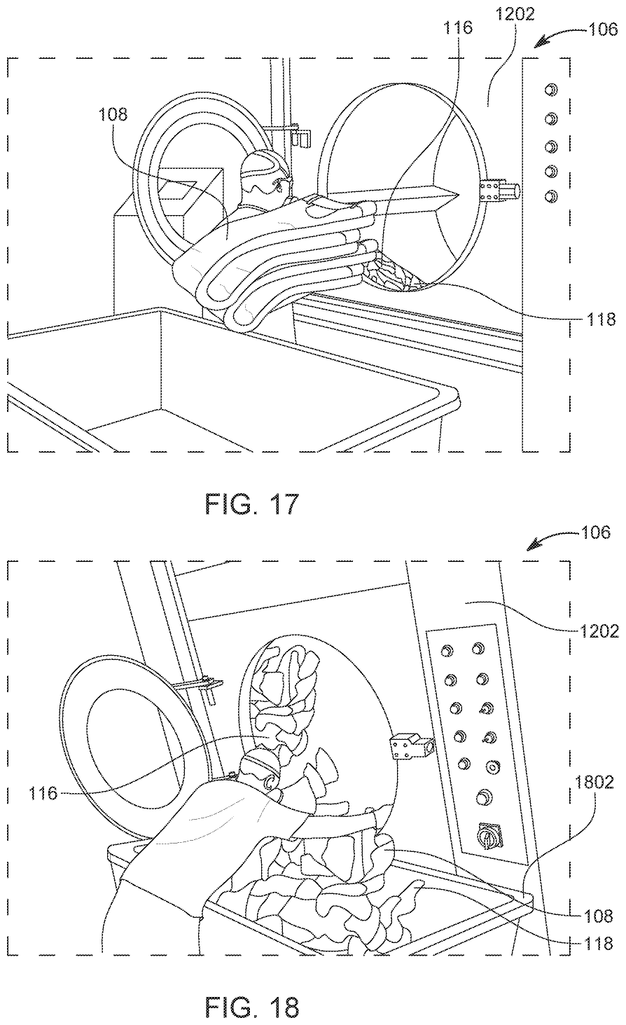

The operation of the ozone machine system 106 is depicted in and described with regard to FIGS. 17 and 18. The garment manufacturing system 100 has been discovered to achieve changes to a garment 108 without losing the garments 108 original quality by only removing protectors, dyes, gums, and contaminants from the garments 108. This process has been shown to reduce electrical and gas consumption by 80%, water consumption by 90%, and the amount of chemicals by 70% over prior developments in the garment manufacturing industry.

The garment manufacturing system 100 can include the use of multiple specific chemicals in order to process the garments 108. The process and use of these chemicals are described below with regard to FIGS. 2, 11, and 14-23.

Illustratively, for example the garment manufacturing system 100 can include the use of water 110, enzymes 112, and carbonate 114. It is contemplated that the carbonate 114 could be mixed with the water 110 in some process steps.

Towels 116 and abrasives 118 can be prepared with an incloud mixture 120. The towels 116 can be microfiber towels. The incloud mixture 120 can include oxalic Acid 122, a humectant 124, and demineralized water 126. Yet further processes can include the use of caustic soda 128, B-Tec-A 130, B-Tec-P 132, and acetic acid 134, as described below.

Referring now to FIG. 2, therein is shown a flow chart for a method of operating the garment manufacturing system 100 of FIG. 1. The method of operating the garment manufacturing system 100 is shown for providing the garments 108 of FIG. 1 with a clean effect, soft touch, and stone medium finish.

The method of operating the garment manufacturing system 100 can include a load 1 step 202. The load 1 step 202 can include loading 100 pieces of the garments 108 into the washing machine system 102 of FIG. 1.

The 100 pieces of the garments 108 can have a total weight of fifty Kilograms, for example. Once the garments 108 are loaded the method can include a rinse 1 step 204. Due to the spray nozzles 310 of FIG. 3 the rinse 1 step 204 uses substantially less water than current technologies and requires only two liters of water are required for each kilo of garments 108.

The rinse 1 step 204 step can rinse the garments 108, loaded in the load 1 step 202 with the water 110 of FIG. 1. More particularly, the garments 108 can be rinsed with 100 liters of the water 110 at 60° C. for 7 minutes during the rinse 1 step 204.

After the rinse 1 step 204, the garments 108 can be drained in a drain 1 step 206. Once drained, an enzyme application step 208 can be run. Due to the spray nozzles 310 the enzyme application step 208 uses substantially less water than current technologies and requires only two liters of water are required for each kilo of garments 108.

The enzyme application step 208 can include applying 75 grams of the enzymes 112 of FIG. 1 together with 100 liters of water for 60 minutes to the garments 108. The enzymes 112 can be neutral enzymes.

The enzyme application step 208 can be an enzyme washing or bio stone washing for providing a softer feel and faded appearance. The enzyme application step 208, however; is applied through the spray nozzles 310 providing an atomization of the enzymes 112 and water 110.

The atomization of the enzymes 112 and the water 110 in the enzyme application step 208 greatly reduces the amount of the water 110 needed as well as the amount of the enzymes 112 needed relative to prior developments.

Furthermore, prior developments in enzymatic processing would release dye which could redeposit on the garment 108. This is known as back staining. With the use of the spray nozzles 310 and the high pressure pump 314 of FIG. 3 the atomized mist of the enzymes 112 and the water 110 do not release the same amount of dye which greatly reduces back staining defects.

The enzymes 112 can for example be a cellulase enzyme, which decomposes cellulose. As an illustrative example, the enzymes can be Enzimatec, Herzime, Neutra Enzimetec, or a combination thereof.

After the enzymes 112 are applied in the enzyme application step 208, the garments 108 can be rinsed with the water 110 and the carbonate 114 of FIG. 1 in a rinse 2 step 210. The enzymes 112 are added to the washing machine during the enzyme application step 208 and then carbonate 114 is added during the rinse 2 step in order to deactivate the previously added enzymes 112.

That is, the combination of water 110 and carbonate 114 deactivates the enzymes 112 used with the garments 108. The carbonate 114 can be replaced with another ingredient such as an alkaline detergent.

More particularly, 100 liters of the water 110 and 50 grams of the carbonate 114 can be used during the rinse 2 step 210. The water 110 and carbonate 114 can then be drained in a drain 2 step 212. Due to the spray nozzles 310 the rinse 2 step 210 uses substantially less water than current technologies and requires only two liters of water are required for each kilo of garments 108.

Once the garments 108 are drained in the drain 2 step 212, the garments 108 can be extracted from the washing machine system 102 in an extract 1 step 214. The garments 108 can then be loaded into the drying machine system 104 of FIG. 1 in a load 2 step 216. The garments 108 are then dried in a dry 1 step 218 and extracted from the drying machine system 104 in an extract 2 step 220.

Prior to the extract 2 step 220, the towels 116 and the abrasives 118, both of FIG. 1, can be prepared in a preparation step 222. During the preparation step 222, the incloud mixture 120 of FIG. 1 can be mixed.

The incloud mixture 120 can be mixed in a clean plastic container with a shaker at a temperature of between 18 and 25 degrees Celsius. When prepared, the incloud mixture 120 will have an active time of 8 hours in an environment of 18 to 36 degrees Celsius.

The incloud mixture 120 can be a mixture of the oxalic Acid 122, the humectant 124, and the demineralized water 126, all of FIG. 1. The oxalic Acid 122 can be an organic acid with the chemical formula: C2HO4, which acts as a catalyst.

It is contemplated that when preparing the incloud mixture 120, 10% of the original material should be the oxalic Acid 122; and when preparing one liter of the incloud mixture 120, 10 grams of the oxalic Acid 122 should be used.

The humectant 124 can be a neutral detergent or soap with the chemical formula: C14H2O. It is contemplated that when preparing the incloud mixture 120, 10-20% of the original material should be the humectant 124; and when preparing one liter of the incloud mixture 120, up to 200 grams of the humectant 124 can be used.

The demineralized water 126 can be a neutral water without minerals, salts, or microorganisms. It is contemplated that when preparing the incloud mixture 120, up to 90% of the original material should be the demineralized water 126; and when preparing one liter of the incloud mixture 120, up to 790 ml of the demineralized water 126 can be used. It has been discovered that the demineralized water 126 prevents UV rays from staining the garment 108.

The UV rays can be used in a radiation step to treat the demineralized water 126 prior to preparing the incloud mixture 120. The UV radiation provides rapid and efficient inactivation of microorganisms through a physical process. When bacteria, viruses, and protozoa are exposed to the germicidal wavelengths of UV light, they become unable to reproduce and infect.

It is important so that the eliminated microorganisms do not contaminate the incloud mixture 120. The UV is applied to the demineralized water 126 in a pipe and is part of the water purification process.

The UV rays can be used to clean micro-organisms from the garments 108. During the preparation step 222, the towels 116 and the abrasives 118 can be loaded into the washing machine system 102 along with 1 or 2 liters of the incloud mixture 120. The incloud mixture 120 is atomized in the washing machine system 102 to coat the towels 116 and the abrasives 118 over the course of a 20 minute cycle time.

The incloud mixture 120 is atomized by creating a very fine mist within the washing machine system 102. All the towels 116 and the abrasives 118 need to have the same amount of water and chemicals. Prior solutions used excessive water and chemicals but the incloud mixture 120 and its atomization improves on both accounts.

The incloud mixture 120 is equally distributed with the atomized mist which also simultaneously requires much less water and chemicals. It has been shown that a humidity of 60-70% in the towels 116 and the abrasives 118 provides unexpected benefits of providing enough incloud mixture 120 without dripping or waste.

The towels 116 and the abrasives 118 are impregnated with the incloud mixture 120 evenly. The incloud mixture 120 is deposited on the towels 116 or the abrasives 118 so that these are the ones that impregnate the garments 108. This indirect application of the incloud mixture 120 onto the garments 108, through the towels 116 and the abrasives 118, improves the garment manufacturing system 100 by providing a more even application onto the garments 108 by being indirect and simultaneously reducing the amount of water required or used.

Once the towels 116 and the abrasives 118 are coated with the incloud mixture 120 in the preparation step 222, the towels 116 or abrasives 118 can be unloaded from the washing machine system 102 and loaded together with the garments 108 into the ozone machine system 106 of FIG. 1 in a load 3 step 224. The garments 108, the towels 116, and the abrasives 118 will undergo an ozone process 226 where ozone, with the chemical formula: O3, is added and is allowed to react with the incloud mixture 120.

During the tumbling of the ozone process 226 some abrasion is also imparted onto the garments 108. The ozone activates the incloud mixture 120 and accelerates the abrasion process in the garments 108.

After the ozone process 226 is complete, the garments 108, the towels 116, and the abrasives 118 can be extracted from the ozone machine system 106 in an extract 3 step 228. During the extract 3 step 228, the garments 108, the towels 116, and the abrasives 118 are placed together in a large tote.

It has been discovered that the towels 116 and the abrasives 118 can provide friction and abrasion for processing the garment 108. Colors and surfaces of the garment 108 can be removed through friction with the abrasives 118 and the towels 116. The incloud mixture 120 can also be transferred to the garments 108 by contact with the towels 116 and the abrasives 118, which can react with the ozone to further process the garments 108 to impart wear, yellow vintage effects, and fashion effects.

After the extract 3 step 228 the garments 108 are loaded again into the washing machine system 102 in a load 4 step 230. Part of the load 4 step 230 can be to separate the garments 108 from the towels 116 and the abrasives 118 within the tote.

The garments 108 will be loaded while the towels 116 and the abrasives 118 will not be. The garments 108 in the washing machine system 102 will next undergo a clean 1 step 232. During the clean 1 step 232 the garments 108 will be cleaned with the caustic soda 128, the B-Tec-A 130, the B-Tec-P 132, and the carbonate 114, all of FIG. 1. Due to the spray nozzles 310 the clean 1 step 232 uses substantially less water than current technologies and requires only two liters of water are required for each kilo of garments 108.

The B-Tec-A 130 can be 2-(2-butoxyethoxy) ethanol, while the B-Tec-P 132 can include: Polyester copolymer, Sodium Alkyl Aryl Sulfonate, 1-Hydroxyethylidene-, and 1-diphosphonic acid. Both the B-Tec-A 130, the B-Tec-P 132 belong to the functional group of ethers or glycol bases. In addition, the product B-Tech-P belongs to the alkyl group (saturated hydrocarbons) and also to the linear alkybenzene sulfanates group. Both the B-Tec-A 130 and the B-Tec-P 132 act as detergents and active tensile products.

The B-Tec-A 130 and the B-Tec-P 132 remove ozone and residues from the incloud mixture 120, giving the garments 108 the necessary cleaning. More particularly, the clean 1 step 232 can wash the garments 108 for 20 minutes at 60 degrees Celsius with 100 liters of the water 110, 50 grams of the caustic soda 128, 40 grams of the B-Tec-A 130, 40 grams of the B-Tec-P 132, and 300 grams of the carbonate 114. The clean 1 step 232 will have a PH of 10, which is basic, while the rinse 1 step 204, the enzyme application step 208, the rinse 2 step 210, and the preparation step 222 will have a PH of 7.

Once the clean 1 step 232 is complete, the garments 108 will undergo a rinse 3 step 234. Particularly, during the rinse 3 step 234, the garments 108 will be rinsed with 100 liters of the water 110 and 100 milliliters of the acetic acid 134 of FIG. 1 for 5 minutes at 25 degrees Celsius.

Due to the spray nozzles 310 the rinse 3 step 234 uses substantially less water than current technologies and requires only two liters of water are required for each kilo of garments 108. The acetic acid 134 can be replaced with citric acid.

Once the rinse 3 step 234 is complete, the garments 108 will undergo a further rinse in a rinse 4 step 236. The rinse 4 step 236 only utilizes 100 liters of the water 110 for 3 minutes at 25 degrees Celsius. Both the rinse 3 step 234 and the rinse 4 step 236 will have a PH of 7. Due to the spray nozzles 310 the rinse 4 step 236 uses substantially less water than current technologies and requires only two liters of water are required for each kilo of garments 108.

After rinsing, the garments 108 are extracted from the washing machine system 102 in an extract 4 step 240. Following the extract 4 step 240, the garments 108 are loaded in a load 5 step 242 into the drying machine system 104 to undergo a final drying process or a dry 2 step 244.

The dry 2 step 244 can dry the garments 108 for 40 minutes at 60 degrees Celsius. The garments 108 can be extracted from the drying machine system 104 in an extract 5 step 246. Once extracted from the drying machine system 104 the garments 108 can undergo a quality assurance evaluation 248 to look for any defects or reworks.

It has been discovered that the unique balance of the incloud mixture 120 generates a molecular reaction to alter the original composition of the cotton fabrics of the garment 108. In addition to the reduction in water, chemicals, and energy, the garment manufacturing system 100 also cleans the garments 108 and removes colorant that is applied to the cotton denim fabric at the mill stage or the dye warp, yarn weaving stage.

Further, the garment manufacturing system 100 provides abrasion of the garments 108 when using the towels 116 or the abrasives 118 and thereby removes contaminants from the cotton fabric. For example, color is removed from the friction of the abrasion.

Yet further, the garment manufacturing system 100 provides smoothness and softness by removing the cover or surface layer of the fabric from the fabric through cleaning and abrasion. This reduces stiffness and gives a soft effect to the touch.

Yet still further, the garment manufacturing system 100 provides a cleaning and bleaching to remove some of the color from cotton weft yarn. Therefore, the garment manufacturing system 100 provides cotton garment changes without losing original quality and only removing protectors, dyes, gums, and contaminants in the cotton.

Yet even further, the garments 108 can be processed without saturating the garment with water. This has been discovered to provide many unexpected benefits and improvements by reducing the color with abrasion and the incloud mixture 120 but with very little water.

The garment manufacturing system 100 provides a clean process that the designers of the fashion brands are eager to see. The garment manufacturing system 100 may have different process steps according to the finish of the brand and design or the fashion season.

There are many benefits including the ability to potentiate this product 7 times with Ozone in the gaseous state. That is, the garment manufacturing system 100 can be enhanced or increased in effectiveness by 7 times its original effectiveness in terms of action on the garment 108. Another benefit includes imparting wear and yellow vintage effects.

The ozone improves the final product by having an antimicrobial effect on the garments 108. The towels 116 can also impart fashion effects onto the garments 108.

Referring now to FIG. 3, therein is shown a front isometric view of the washing machine system 102 of FIG. 1 in a first embodiment. The washing machine system 102 can include multiple subsystems and components.

Two main components of the washing machine system 102 include a washing machine 302 and an atomization system 304. The washing machine 302 can include a body 306 housing the basket 1402 of FIG. 14 and a door 308.

The door 308 can include spray nozzles 310 and a hatch 312. It has been discovered that the spray nozzles 310 can produce a thick cloud of the water 110, water 110 and enzymes 112, water 110 and carbonate 114, the incloud mixture 120, water 110 and caustic soda 128, B-Tec-A 130, B-Tec-P 132, and water 110 and acetic acid 134 all of FIG. 1.

The atomization of these chemicals during the operation of the garment manufacturing system 100 drastically reduces water consumption and energy required to dry excessive moisture. Four of the spray nozzles 310 can be distributed along the door 308.

The atomization system 304 can include the spray nozzles 310, which can be coupled to a high pressure pump 314. In one contemplated embodiment, the high pressure pump 314 can have a flow capacity of 31 L/hr.

The atomization system 304 is further shown with an atomization tank 316 and an atomization control 318. Illustratively, for example, the incloud mixture 120 could be loaded into the atomization tank 316, pumped through the high pressure pump 314, pumped through the spray nozzles 310 and into the basket 1402.

The atomization control 318 can determine the precise timing and flow into the washing machine 302 during process. This process, flow rate, and flow time can be changed for different garment styles and finishes.

The washing machine 302 is further shown having a cold water inlet 320, a steam inlet 322, and an air inlet 324. The cold water inlet 320 can provide the water 110, the steam inlet 322 can provide steam, and the air inlet 324 can provide air for processing the garments 108 of FIG. 1.

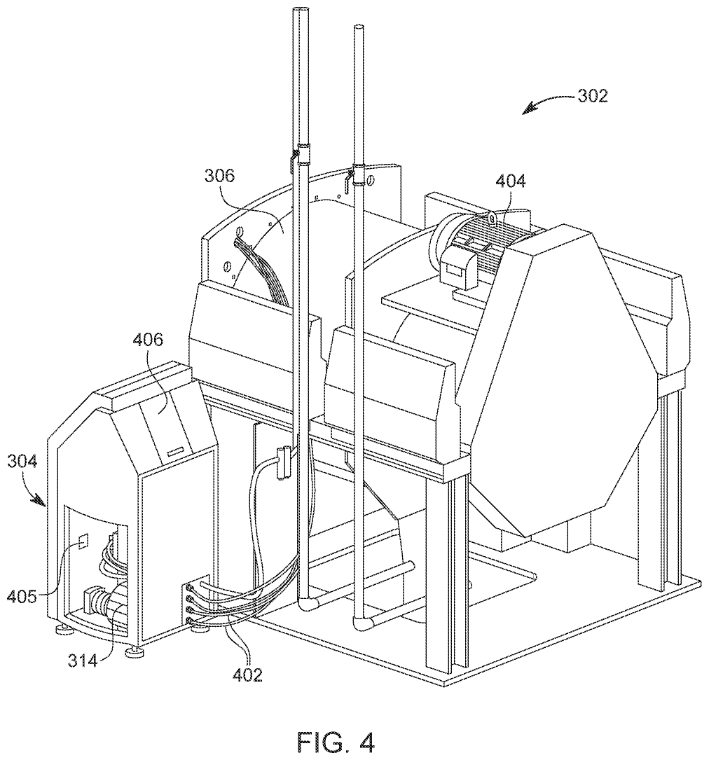

Many improvements have been included into the washing machine system 102. This includes reprogramming the revolutions per minute of the basket 1402 using a frequency variator 405 of FIG. 4.

The function of the frequency variator 405 is to regulate the speed of the electric motor 404 of FIG. 4 with the objective that the electricity that reaches the electric motor 404 is adjusted to the actual application demand. It is contemplated that the frequency variator 405 can also control the acceleration and deceleration of the electric motor 404 during starting or stopping.

The spray nozzles 310 represent a substantial improvement in reducing waste of water, chemicals, and energy. The hatch 312 provides many improvements to the washing machine system 102.

One improvement of the hatch 312 is that the process can be varied by adding chemicals during a running cycle. Furthermore, the hatch 312 can allow inspections and monitoring of the process and the garments 108. Another improvement to the washing machine system 102 is an insulator 1404 of FIG. 14 positioned around the door 308 to prevent condensation from forming based on the temperature differences inside and outside the washing machine 302.

Referring now to FIG. 4, therein is shown a back isometric view of the washing machine system 102 of FIG. 1. The washing machine 302 is shown connected to the atomization system 304 with high pressure lines 402.

The high pressure lines 402 can connect the high pressure pump 314 to the spray nozzles 310 of FIG. 3 on the door 308 of FIG. 3 of the washing machine 302. The basket 1402 of FIG. 14 can be driven by an electric motor 404 which can be programmed for a specific spin time, total process time, and RPM of the basket 1402 of FIG. 14.

The RPM of the basket 1402 can be controlled by a frequency variator 405 coupled to the electric motor 404. The atomization tank 316 is shown with an atomization tank door 406 covering the atomization tank 316.

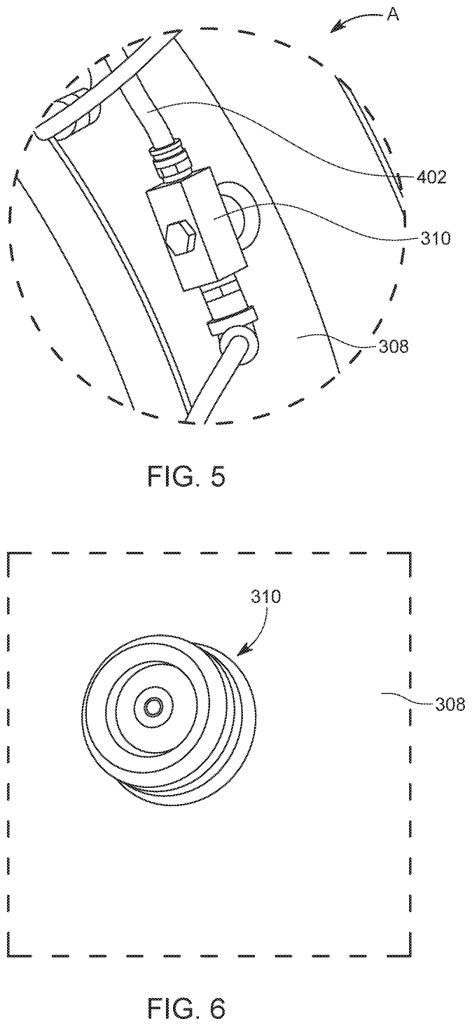

Referring now to FIG. 5, therein is shown a front isometric view of the Area A of FIG. 3. The Area A is depicted covering one of the spray nozzles 310 from outside of the door 308. The spray nozzle 310 is coupled to the high pressure lines 402, which feed the water 110, water 110 and enzymes 112, water 110 and carbonate 114, the incloud mixture 120, water 110 and caustic soda 128, B-Tec-A 130, B-Tec-P 132, and water 110 and acetic acid 134 all of FIG. 1 into the basket 1402 of FIG. 14.

Referring now to FIG. 6, therein is shown an internal isometric view of the spray nozzle 310 of FIG. 5. The spray nozzle 310 is shown from inside the door 308. The spray nozzle 310 can disperse the liquids and chemicals into the basket 1402 of FIG. 14 without dripping.

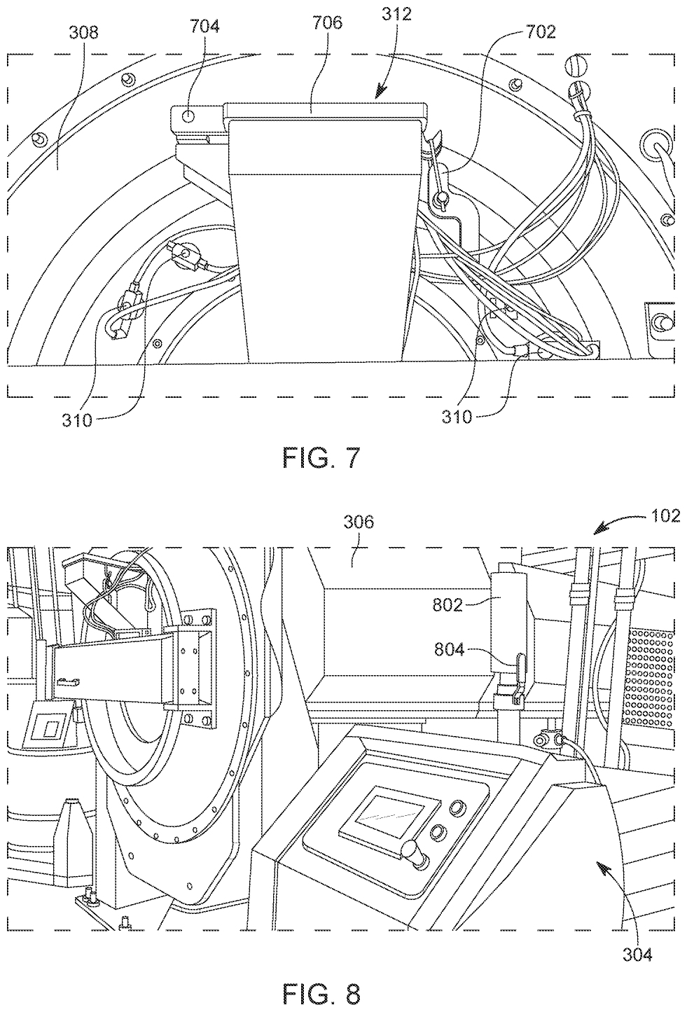

Referring now to FIG. 7, therein is shown a front isometric view of the hatch 312 of FIG. 3. The hatch 312 is shown extending through the door 308.

The hatch 312 can include a latch 702, a hinge 704, and a hatch door 706. The hatch door 706 can open when the latch 702 is unfastened.

When the hatch door 706 is open, chemicals can be added and measurements can be taken. The hatch 312 can be positioned between the spray nozzles 310.

Referring now to FIG. 8, therein is shown a front isometric view of the washing machine system of FIG. 1 in a second embodiment. The washing machine system 102 in the second embodiment is shown with the same configuration as the first embodiment, however, a hopper 802 is added through which chemicals can be loaded manually.

The hopper 802 can feed directly into the basket 1402 of FIG. 14 or can be injected through the atomization system 304 by feeding through the high pressure pump 314 of FIG. 3 and the spray nozzles 310 of FIG. 3. The hopper 802 can be gated with a quarter turn valve 804.

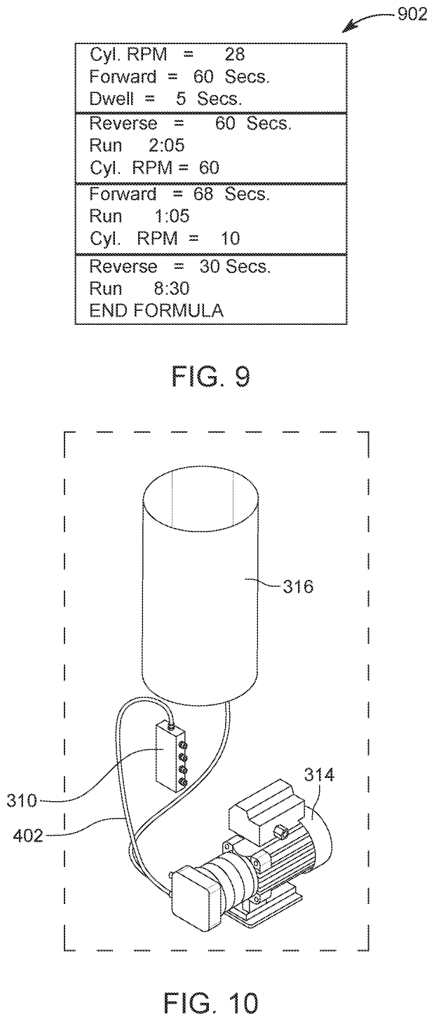

Referring now to FIG. 9, therein is shown a graphical depiction of an atomization tank interface panel 902 for the washing machine system 102 of FIG. 1.

The washing machine system 102 can be programmed for cycle times and RPM. These process variables are depicted on the atomization tank interface panel 902. Programming the washing machine 302 of FIG. 3 allows us to change the RPM of the basket 1402 of FIG. 14, with the intention of giving different drop or drape to the garment according to the finish desired.

Referring now to FIG. 10, therein is shown an isometric view of the high pressure pump 314 of FIG. 3. The high pressure pump 314 is shown coupled to the atomization tank 316 and to the spray nozzles 310 with the high pressure lines 402.

Referring now to FIG. 11, therein is shown a front isometric view of components used with the garment manufacturing system 100. The garment manufacturing system 100 can be depicted with the drying machine system 104 comprising a dryer.

The garment manufacturing system 100 is further depicted with the garments 108, the towels 116 and the abrasives 118. Furthermore, the garment manufacturing system 100 is depicted with the enzymes 112, the carbonate 114, the incloud mixture 120, caustic soda 128, B-Tec-A 130, B-Tec-P 132, and acetic acid 134. These chemicals, garments 108, towels 116, and abrasives 118 can be combined in a process as specified by a process recipe 1102.

Referring now to FIG. 12, therein is shown an isometric view of the ozone machine system 106 of FIG. 1. The ozone machine system 106 can have multiple subsystems and subcomponents. Importantly, the ozone machine system 106 can include an ozone washing machine 1202.

The ozone washing machine 1202 can be supplied by ozone from supporting subsystems including an air compressor 1204. Air generated by the air compressor 1204 is passed through concentrator tanks 1206.

The concentrator tanks 1206 can obtain 98% pure O2. The oxygen from the concentrator tanks 1206 can be passed to a receiving tank 1208 and then to a reactor 1210.

Within the reactor 1210, the oxygen will undergo a corona treatment, which separates the oxygen molecules. The resulting ozone is distributed to cluster of valves 1212 and supplied to ozone washing machine 1202. An ozone washing machine control panel 1214 can control the concentrations of ozone, duration, and timing of the ozone applications along with spin RPM and temperatures.

Referring now to FIG. 13, therein is shown a top view of an electronic card 1302 for the reactor 1210 of FIG. 12. The electronic card 1302 can be within the reactor 1210 and can be modified to achieve higher oxygen purity.

Particularly, the electronic card 1302 is adjusted to reach up to 300 g/Nm3 of ozone. It has been unexpectedly discovered that 300 g/Nm3 of the ozone provides unexpected benefits of being the level of ozone concentration that effectively reacts with the incloud mixture 120, smaller concentrations do not provide the same reaction with the incloud mixture 120 and do not provide the same ability to process the garment 108.

Referring now to FIG. 14, therein is shown a front isometric view of a load 1 step of the washing machine system 102 for the garments 108. The garments 108 can be loaded into the basket 1402.

The washing machine 302 is shown further having an insulator 1404 positioned around the inside of the door 308 to prevent condensation from forming based on the temperature differences inside and outside the washing machine 302. The back side of the hatch 312 is also shown feeding through the door 308. Furthermore, the inside of the door 308 depicts the spray nozzles 310 distributed thereon.

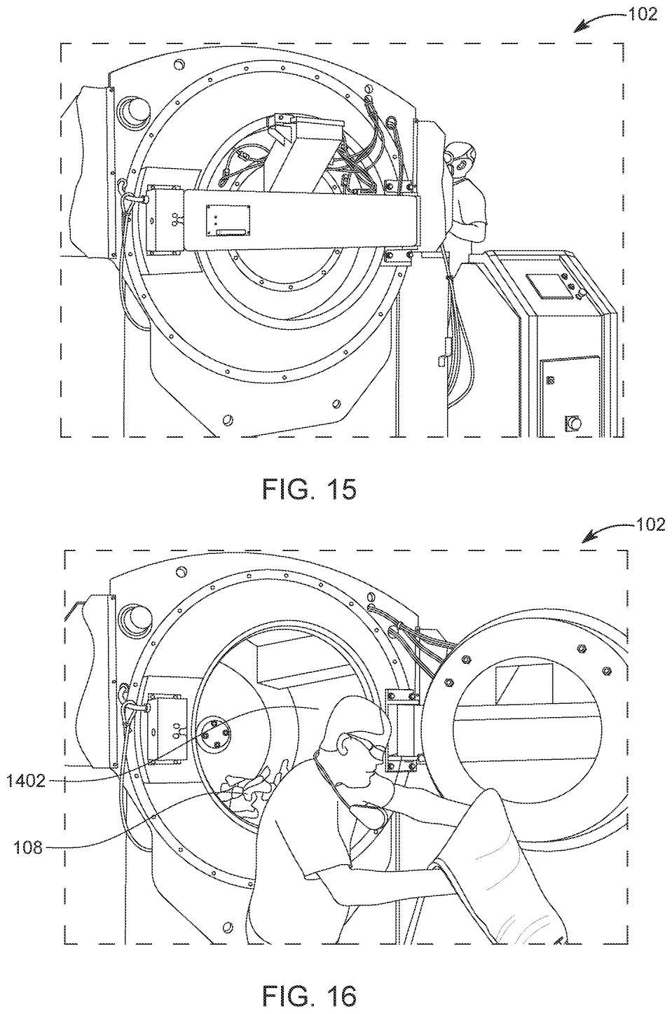

Referring now to FIG. 15, therein is shown a front isometric view of a chemical loading step of the washing machine system 102. Particularly, the chemicals for the enzyme application step 208 of FIG. 2 or the rinse 2 step 210 of FIG. 2 can be added to the hopper 802 of FIG. 8.

Referring now to FIG. 16, therein is shown a front isometric view of an extract 1 step of the washing machine system 102 for the garments 108. The garments 108 can be removed from the basket 1402.

Referring now to FIG. 17, therein is shown a front isometric view of a load 3 step of the ozone machine system 106 for the garments 180, the abrasives 118, and the towels 116. The ozone washing machine 1202 can be loaded with the garments 108 and the towels 116 and abrasives 118 that were prepared in the preparation step 222 of FIG. 2.

Referring now to FIG. 18, therein is shown a front isometric view of an extract 3 step of the ozone machine system 106 for the garments 108, the abrasives 118, and the towels 116. The ozone washing machine 1202 can tilt forward to facilitate unloading and the garments 108 unloaded into a tote 1802.

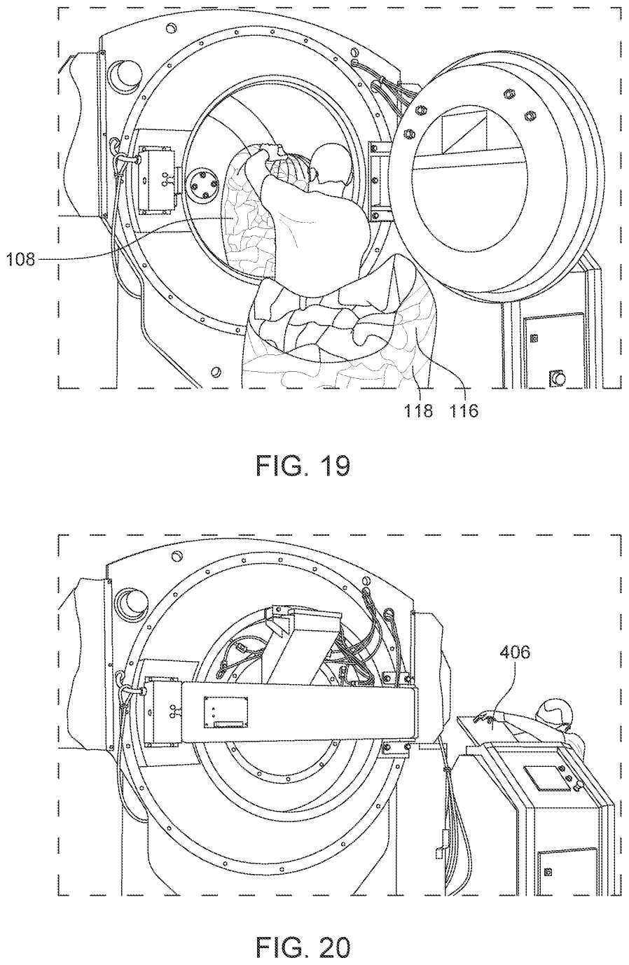

Referring now to FIG. 19, therein is shown a front isometric view of the load 4 step 230 for the garments 108. During the load 4 step 230, the garments 108 can be separated from the towels 116 and the abrasives 118 within the tote 1802 of FIG. 18.

Referring now to FIG. 20, therein is shown a front isometric view of a chemical loading step. Illustratively, chemical loading step can include loading the incloud mixture 120 or solutions of the caustic soda 128, B-Tec-A 130, B-Tec-P 132, and carbonate 114 all of FIG. 1 into the atomization tank 316 of FIG. 3.

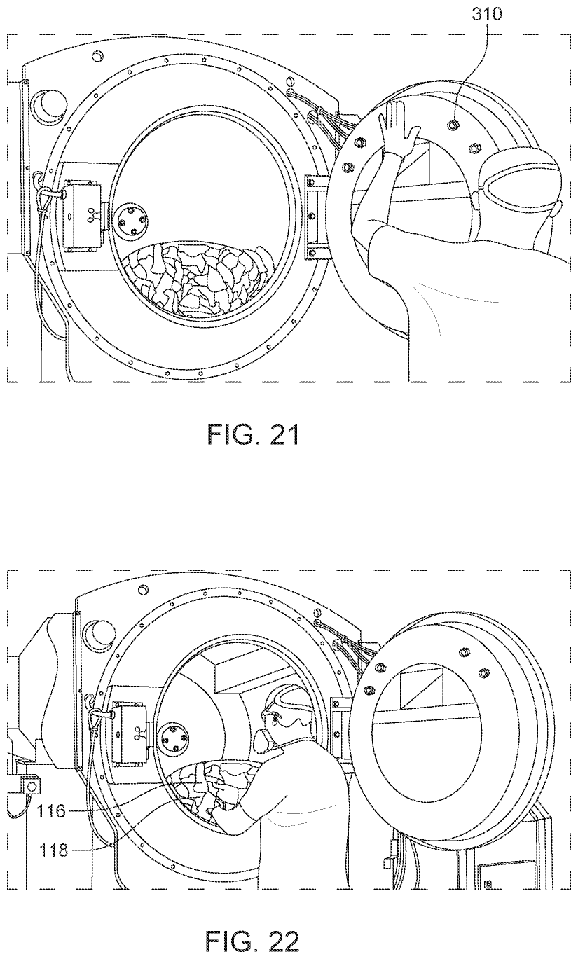

Referring now to FIG. 21, therein is shown a front isometric view of an atomization check step. The spray nozzles 310 can be checked to ensure proper atomization of chemicals loaded into the atomization tank 316 of FIG. 3. Proper atomization will be a thick mist or cloud.

Referring now to FIG. 22, therein is shown a front isometric view of a moisture monitoring step for the towels 116 and abrasives 118 during the preparation step 222 of FIG. 2. The chemicals can be equally distributed with the atomized mist which also simultaneously requires much less water and chemicals. It has been shown that a humidity of 60-70% in the towels 116 and the abrasives 118 provides unexpected benefits of providing enough incloud mixture 120 of FIG. 1 without dripping or waste.

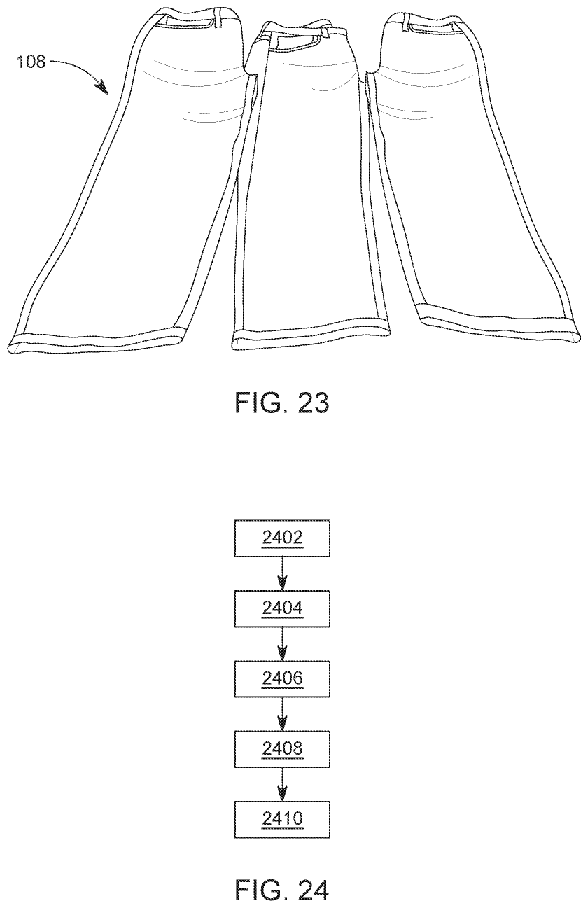

Referring now to FIG. 23, therein is shown a front isometric view of a quality assurance step for the garments 108. The garments 108 can be inspected for proper cleaning, proper finish, and any other defects that might be present prior to being packaged and shipped.

Referring now to FIG. 24, therein is shown a block diagram of a method of assembling the garment manufacturing system 100. The method of assembling can include: providing a washing machine for washing a garment in a block 2402; positioning a spray nozzle within the washing machine in a block 2404; coupling a high pressure pump to the spray nozzle, the spray nozzle being configured to atomize within the washing machine: a catalyst, a humectant, and water in a block 2406; providing an ozone washing machine for applying ozone to the garment in a block 2408; and providing a dryer for drying the garment in a block 2410.

Thus, it has been discovered that the garment manufacturing system furnishes important and heretofore unknown and unavailable solutions, capabilities, and functional aspects. The garment manufacturing system and methods provide lower water consumption, lower energy consumption, and lower chemical consumption for the same quantity of garments. The resulting configurations are straightforward, cost-effective, uncomplicated, highly versatile, accurate, sensitive, and effective, and can be implemented by adapting known components for ready, efficient, and economical manufacturing, application, and utilization.

While the garment manufacturing system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

1. A garment manufacturing system comprising:
a washing machine;
a spray nozzle positioned within the washing machine;
a high pressure pump coupled to the spray nozzle, the spray nozzle being configured to atomize within the washing machine: a catalyst, a humectant, and water; and
an abrasive sheet within the washing machine, the abrasive sheet coated with the catalyst, the humectant, and the water.

2. The system of claim 1 further comprising: a variator configured to lower a speed of a basket within the washing machine.

3. The system of claim 1 further comprising: an insulator positioned on a door of the washing machine and peripheral to the spray nozzle, the insulator configured to prevent condensation from forming based on a temperature difference inside and outside the washing machine.

4. The system of claim 1 further comprising: a hatch within a door of the washing machine, the hatch providing access for monitoring and chemical inputs into the washing machine during operation.

5. The system of claim 1 wherein the spray nozzle is configured to atomize within the washing machine:
enzymes and the water;
caustic soda, B-Tec-A, B-Tec-P, and carbonate;
acetic acid and the water; or
carbonate and the water.

6. A garment manufacturing system comprising:
a washing machine for washing a garment;
a spray nozzle positioned within the washing machine;
a high pressure pump coupled to the spray nozzle, the spray nozzle being configured to atomize within the washing machine: a catalyst, a humectant, and water;
an ozone washing machine for applying ozone to the garment;
an abrasive sheet within the washing machine, the abrasive sheet coated with the catalyst, the humectant, and the water, the abrasive sheet within the ozone washing machine for imparting abrasion onto the garment; and
a dryer for drying the garment.

7. The system of claim 6 further comprising: oxygen concentrator tanks coupled to the ozone washing machine.

8. The system of claim 6 further comprising: a reaction chamber coupled to the ozone washing machine providing a corona treatment for creating the ozone from oxygen stored in oxygen concentrator tanks.

9. The system of claim 6 further comprising: an electronics card coupled to the ozone washing machine, the electronics card modified to reach concentrations of 300 g/Nm3 of the ozone.

10. The system of claim 6 wherein: the ozone washing machine is configured to tumble and apply the ozone to a towel or the abrasive sheet.

11. A method of assembling a garment manufacturing system comprising:
providing a washing machine;
positioning a spray nozzle within the washing machine; and
coupling a high pressure pump to the spray nozzle, the spray nozzle being configured to atomize within the washing machine: a catalyst, a humectant, and water; and
providing an abrasive sheet within the washing machine, the abrasive sheet coated with the catalyst, the humectant, and the water.

12. The method of claim 11 further comprising: coupling a variator to the washing machine, the variator configured to lower a speed of a basket within the washing machine.

13. The method of claim 11 further comprising: positioning an insulator on a door of the washing machine and peripheral to the spray nozzle, the insulator configured to prevent condensation from forming based on a temperature difference inside and outside the washing machine.

14. The method of claim 11 further comprising: forming a hatch within a door of the washing machine, the hatch providing access for monitoring and chemical inputs into the washing machine during operation.

15. The method of claim 11 wherein positioning the spray nozzle includes positioning the spray nozzle configured to atomize within the washing machine: enzymes and the water;
caustic soda, B-Tec-A, B-Tec-P, and carbonate;
acetic acid and the water; or
carbonate and the water.

16. The method of claim 11 wherein:
providing the washing machine includes providing the washing machine configured to wash a garment; and
further comprising:
providing an ozone washing machine for applying ozone to the garment; and
providing a dryer for drying the garment.

17. The method of claim 16 further comprising: coupling oxygen concentrator tanks to the ozone washing machine.

18. The method of claim 16 further comprising: coupling a reaction chamber to the ozone washing machine, the reaction chamber providing a corona treatment for creating the ozone from oxygen stored in oxygen concentrator tanks.

19. The method of claim 16 further comprising: coupling an electronics card to the ozone washing machine, the electronics card modified to reach concentrations of 300 g/Nm3 of the ozone.

20. The method of claim 16 wherein: providing the ozone washing machine includes providing the ozone washing machine configured to tumble and apply the ozone to a towel or the abrasive sheet.

21. A method of operating a garment manufacturing system comprising:
atomizing enzymes and water onto to a garment;
atomizing a catalyst, a humectant, and the water onto a towel;
tumbling the garment and the towel with ozone;
atomizing caustic soda, B-Tec-A, B-Tec-P, and carbonate onto the garment;
rinsing the garment; and
drying the garment.

22. The method of claim 21 wherein atomizing includes spraying an atomized mist into a basket of a washing machine.

23. The method of claim 21 wherein: atomizing the catalyst includes atomizing oxalic acid.

24. The method of claim 21 wherein: atomizing the humectant includes atomizing a neutral detergent or soap.

25. The method of claim 21 further comprising: rinsing the garment with the water and the carbonate after atomizing the enzymes and the water onto the garment.

26. The method of claim 21 further comprising: atomizing the catalyst, the humectant, and the water onto an abrasive.

27. The method of claim 26 further comprising: tumbling the garment with the abrasive.

28. The method of claim 21 wherein: rinsing the garment includes rinsing the garment with the water and acetic acid.

29. The method of claim 21 wherein: atomizing the catalyst, the humectant, and the water onto the towel includes atomizing the catalyst, the humectant, and the water onto the towel until the towel has a humidity of 60-70%.

30. The method of claim 21 wherein: the catalyst, the humectant, and the water react with the ozone in an ozone washing machine.
